(19) United States
(12) Patent Application Publication
(10) Pub. No.: US 2013/0117082 A1
(43) Pub. Date: May 9, 2013

(54) Electronic Shopping System

(71) Applicant: Haisam Sidani, Dubai (AE)

(72) Inventor: Haisam Sidani, Dubai (AE)

(73) Assignee: A.A. THORNTON & CO., London (GB)

(21) Appl. No.: 13/696,043

(22) PCT Filed: May 5, 2011
(86) PCT No.: PCT/IB2011/001425

§ 371 Date: Jan. 9, 2013

(30) Foreign Application Priority Data
May 6, 2010 (GB) 1007604.0

(51) Int. Cl. G06Q 30/06

(52) U.S. Cl. CPC G06Q 30/0601
USPC 705/14.4; 705/26.1; 705/26.61

(57) ABSTRACT

The present invention relates to a shopping container comprising an electronic device having means for communicating with a purchaser of a product to be sold. The invention also relates to a system comprising a location for displaying a product to be sold to a purchaser and a portable electronic device comprising means for communicating with a purchaser. The portable electronic device is activated so as to communicate, in use, with a purchaser in response to the electronic device being positioned within a pre-determined distance of the product location.

The present invention relates to a shopping system and to a shopping container and an apparatus for electrically charging a shopping container.

It is well known in the retail industry to advertise products and provide product information adjacent a location where products are displayed for sale. Typically, product information is printed on paper or cardboard and positioned in a prominent location in such a way as to clearly indicate that the displayed information relates to a particular product for sale. Information which may be displayed can include the price at which the product is being sold or, for example, a sell-by-date. It is also becoming increasingly common in large supermarket stores to display product price information on an electronic display which is mounted on a shelf or other support unit on which a product is displayed for sale.

However, a problem with these prior art systems is that the information provided is limited and can be difficult for a potential purchaser to see, particularly in a busy supermarket where access to the product information display can be restricted due to the presence of other shoppers.

An object of the present invention is to provide an improved system for displaying product information.

A first aspect of the present invention provides a shopping container comprising an electronic device; characterised in that the electronic device comprises means for communicating with a purchaser of a product to be sold. The shopping container may be a conventional shopping trolley or wire basket, but provided with an electronic device which communicates with a shopper pushing the shopping trolley or carrying the basket. The communication may be such as to convey information about a product in the immediate vicinity of the shopper.

Further features of the invention are provided as recited in the appended dependent claims 2 to 37, 68 to 71.

A second aspect of the present invention provides a shopping container comprising a power supply means for providing electric power, and an electrical connector for electrically connecting the shopping container to apparatus for electrically charging the power supply means. Again, the shopping container may be a conventional shopping trolley or wire basket, but with the provision of a power supply means and an electrical connector. The power supply means allows for the electrical powering of a further electronic device such as an electronic device for communicating product information to a purchaser. This electronic device may be selectively removed from the shopping container and reattached. In so doing, the device may be disconnected and reconnected with the power supply means of the shopping container.

Further features of the invention are provided as recited in the appended dependent claims 39 to 44.

A third aspect of the present invention provides apparatus for electrically charging one or more shopping containers as recited in the appended claims 1 to 44, the charging apparatus comprising one or more electrical connectors for electrically connecting the apparatus to one or more of said shopping containers. A shopping container is electrically connected to the apparatus and an electrical charge is conducted to the shopping container. In this way, the shopping container is provided with electrical power which may be stored for future use. For example, the electrical power may be stored by a rechargeable power supply device which provides electric power to an electronic device for communicating with a purchaser of a product to be sold.

Further features of the invention are recited in the appended dependent claims 46 to 59.

A fourth aspect of the present invention provides a system comprising one or more shopping containers as claimed in any of the appended claims 1 to 44, and apparatus as claimed in any of the appended claims 45 to 59 for electrically charging one or more shopping containers.

Further features of the invention may be provided as recited in the appended dependent claims 61 and 62.

A fifth aspect of the present invention provides a system comprising a location for displaying a product to be sold to a purchaser; and a portable electronic device comprising means for communicating with a purchaser; characterised in that the portable electronic device is activated so as to communicate, in use, with a purchaser in response to said electronic device being positioned within a predetermined distance of said product location. The electronic device may be comprised in a shopping container such as the one recited above in relation to the first to fourth aspects of the present invention.

An advantage of the present invention is that a purchaser may be readily provided with a wide range of product information and/or marketing and promotional information.

Embodiments of the present invention will now be described with reference to the accompanying drawings, in which:

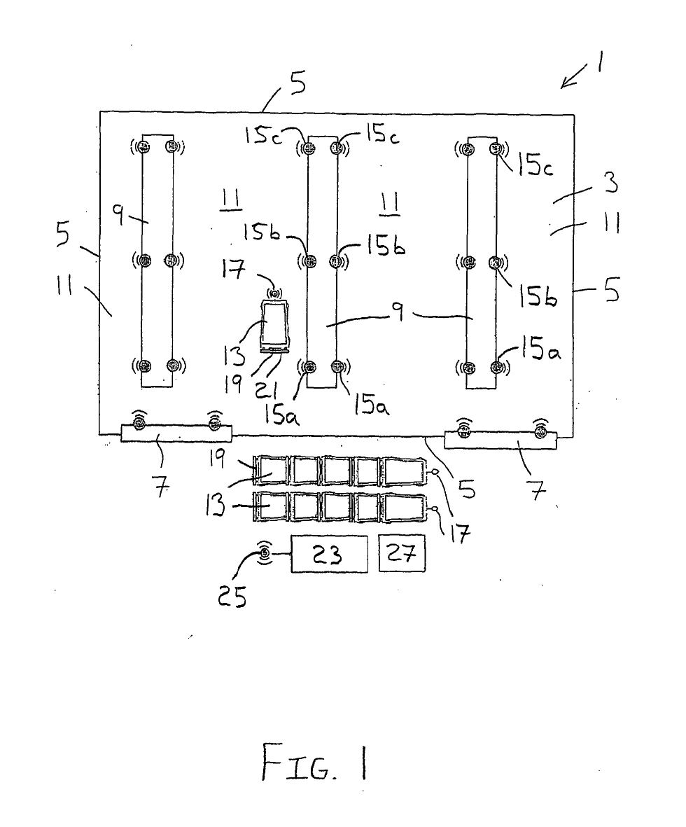

FIG. 1 is a schematic plan view of a supermarket according to the present invention;

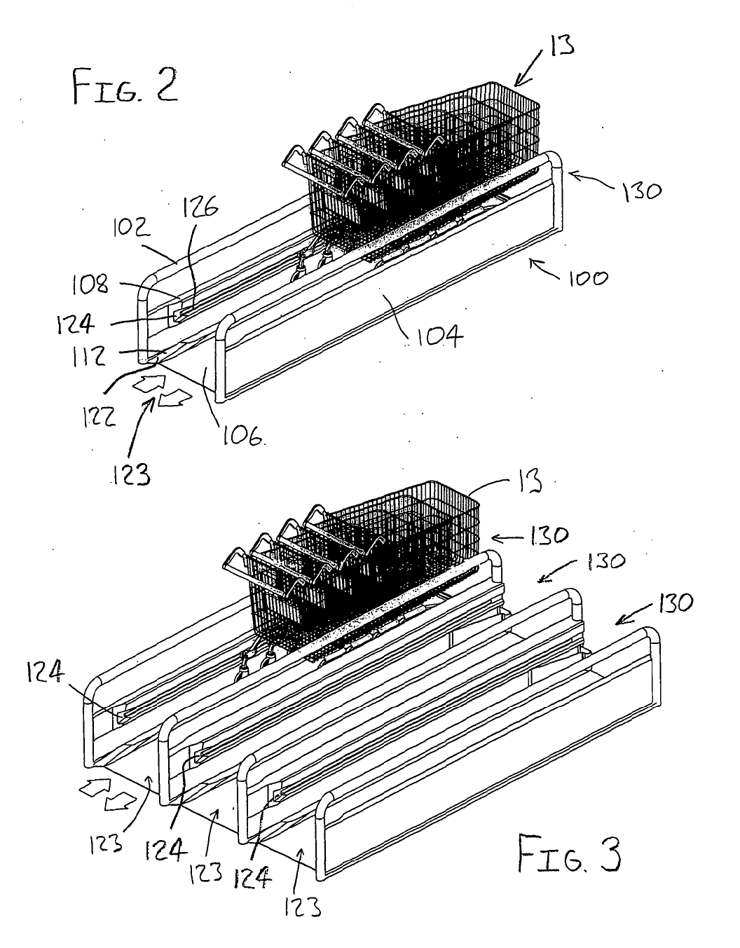

FIG. 2 is a perspective view of a first electrical charging apparatus according to the present invention;

FIG. 3 is a second electrical charging apparatus according to the present invention;

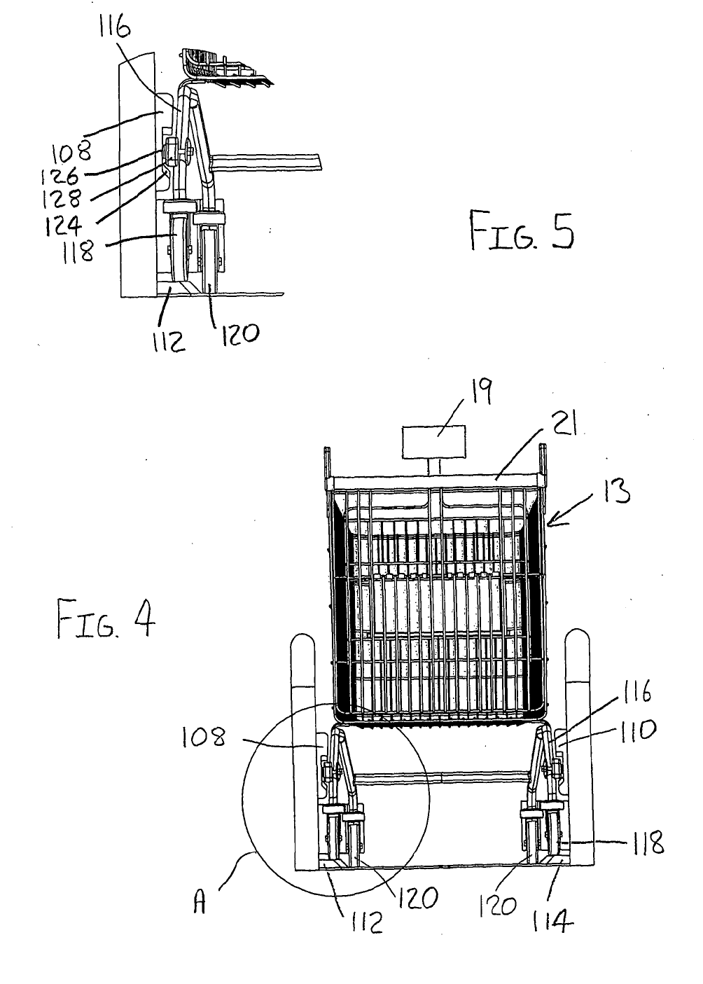

FIG. 4 is a rear view of the first electrical charging apparatus shown in FIG. 2;

FIG. 5 is an enlarged view of the detail enclosed by circle A in FIG. 4;

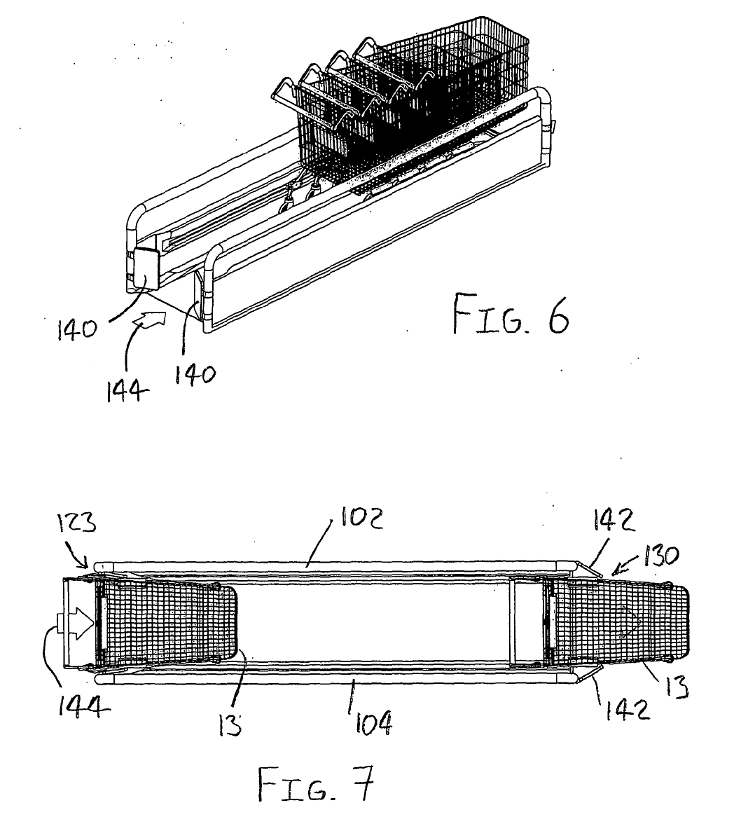

FIG. 6 is a perspective view of a third electrical charging apparatus according to the present invention;

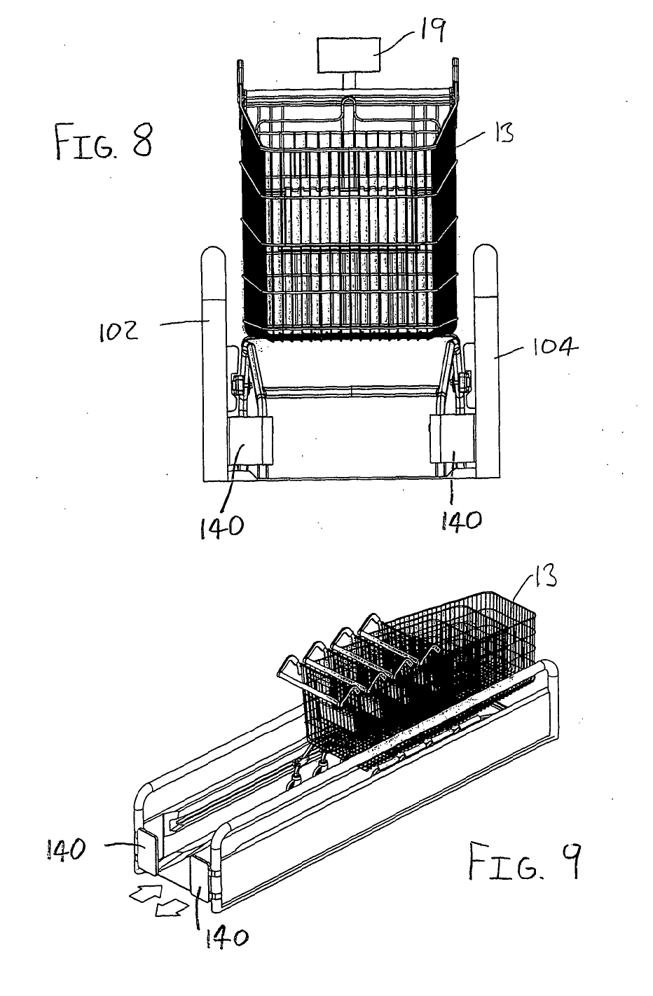

FIG. 7 is a plan view of the third electrical charging apparatus shown in FIG. 6;

FIG. 8 is a rear view of the third electrical charging apparatus shown in FIG. 6;

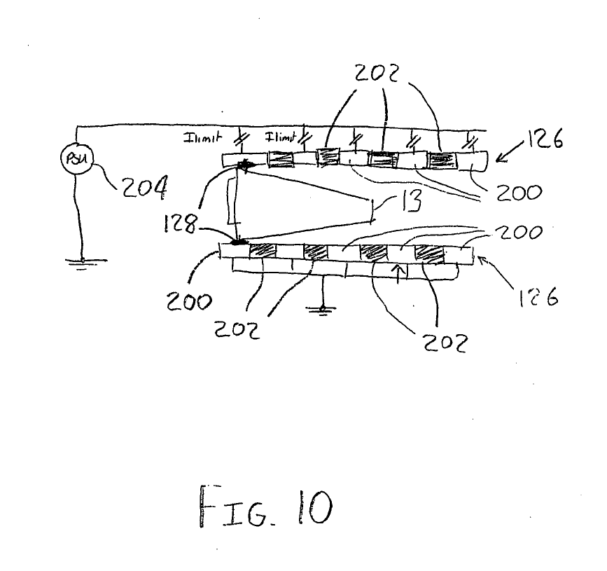

FIG. 9 is a perspective view of the third electrical charging apparatus shown in FIG. 6; and

FIG. 10 is a schematic plan view of the electrical charging connectors of the apparatus shown in FIG. 6.

A schematic plan view of a supermarket shop floor is shown in FIG. 1 of the accompanying drawings. However, it will be understood that the present invention is applicable to other types of shop and venue for marketing and selling products and services.

The schematic supermarket 1 shown in FIG. 1 comprises a shop floor 3 enclosed by a plurality of walls 5. Two doors 7 allow shoppers/purchasers to enter and exit the supermarket shop floor 3.

Inside the supermarket 1, three shelf units 9 are arranged in a conventional fashion parallel to one another so as to form aisles 11 there between and with adjacent walls 5. The shelf units 9 allow for a plurality of different products to be displayed for sale to a purchaser. Typical products displayed on the shelf units 9 within a supermarket are, for example, food and household cleaning products. The aisles 11 are suitable for a purchaser to walk along in order to view products displayed on the shelf units 9. Typically, a purchaser pushes a shopping trolley along the aisles 11 or carries a wire shopping basket. A shopping trolley 13 (shopping container) according to the present invention is shown located in an aisle 11 in FIG. 1.

Each of the shelf units 9 comprises a plurality of transmitters 15 located along the length of the prospective shelf unit. In the embodiment shown in FIG. 1, each shelf unit 9 is provided with three transmitters 15a, 15b, 15c along each side of the shelf unit 9 (wherein one side of a shelf unit displays products accessible from a first aisle 11 and the other side of the shelf unit 9 displays products accessible from a second aisle 11). An alternative number of transmitters may be used in a different embodiment. Of the three transmitters provided on each side of a shelf unit 9, one transmitter 15a, 15c, is located at either end of the shelf unit 9 with the third transmitter 15b being located therebetween half way along the shelf unit 9.

Each transmitter 15 transmits information relating to the location of the transmitter in the supermarket and/or to the identity of a particular transmitter and/or a particular product displayed on the shelf unit 9 in the immediate vicinity of the particular transmitter 15. For example, the left hand side of the central shelf unit 9 as shown in FIG. 1 may display apples, bananas and carrots, wherein the apples are displayed in the vicinity of the first transmitter 15a, the bananas are displayed in the vicinity of the middle transmitter 15b, and the carrots are displayed in the vicinity of the third transmitter 15c. The signals transmitted by the transmitters 15 are received by an electronic receiver 17 which is mounted on a shopping trolley. Control circuitry provided on the shopping trolley 13 allows the processing of the strongest signal from any one of the transmitters 15, on the assumption that the strongest signal is received from the transmitter nearest to the trolley 13. Accordingly, it is the information transmitted from the transmitter 15 nearest to the trolley 13 that is processed and communicated to the purchaser pushing the trolley 13. As a consequence, the purchaser is provided with information relating to the product in his immediate vicinity. For example, when a trolley is determined to be nearest to a particular transmitter, then product or advertising information associated with that particular transmitter is communicated to the purchaser.

The information may be communicated to the purchaser in a number of different ways. For example, the information may be communicated visually or audibly, or by using both of these techniques. The trolley 13 is provided with a 4.3 inch or, alternatively, a 7 inch touch sensitive electronic LCD screen 19 and one or more electronic audio speakers. The screen 19 and audio speakers are a unitary device which is mounted to the push bar/handle 21 of the shopping trolley. Accordingly, as a trolley is pushed around a supermarket, information (perhaps in the form of a video) relevant to the trolley's location in the supermarket is automatically presented to a purchaser.

The screen 19 is used for displaying advertisements and/or information about the product in the immediate vicinity of the trolley 13 (and the purchaser/shopper pushing the trolley 13). This information may comprise one or more of product price information, product sell-by-date information and product technical information and/or other promotional information (relating to the nearby product or products, and/or to related or similar products). The information may also relate to product coupons entitling a purchaser to an effective reduction in the price of an associated product. The audio speakers may provide and audible signal to attract the attention of a purchaser when, for example, a product coupon is available for a nearby product. A device for vibrating a part of the shopping container, for example the handle of the shopping container, may also be provided and may be used for this purpose. The vibration device may be programmed to produce a vibration of the handle at approximately the same time the receiver 17 receives a signal from the transmitter 15 communicating, to a purchaser, information associated with a product to be sold. Preferably, the vibration occurs at the beginning of the communication to the purchaser. This vibration will therefore alert the purchaser that a new set of information is being displayed on the screen 19. For example, as a purchaser walks down an isle 11, they may pass transmitter 15b. The transmitter 15b sends a signal regarding the product information to be displayed on the screen 19 to the receiver 17 on the shopping trolley 13. When this information is presented on the screen 19, a part of the shopping trolley 13, for example the handle, will vibrate. This will alert the purchaser that new product information is being displayed and draw their attention to the screen 19. The purchaser will then review the new product information, which will assist them in their purchasing decisions. The trolley 13 may be programmed to vibrate each time the receiver 17 receives a signal to present new product information on the screen 19.

In addition to messages being presented to a purchaser's screen 19 in response to receiving a signal from the transmitter 15 at designated locations, messages may also be programmed to be sent to the screen at random intervals any time during shopping, or when movement of the trolley is detected. Preferably, the handle vibrates whenever a message is sent at random or in response to movement of the trolley, to indicate a message has been presented on the screen.

In addition to the display screen 19 and audio speakers, or as an alternative thereto a printer (not shown) may be provided on the shopping trolley 13 for communicating information to a purchaser. This printer may also be used to print a coupon in response to an instruction provided by the purchaser, perhaps by means of the touch sensitive screen.

Ideally, information will be communicated to a purchaser which relates to products within a distance of 1.5 meters of the receiver 17.

In the system described above in relation to FIG. 1, the electronic transmitters 15 may transmit product information. However, the transmitters 15 primarily transmit information relating to the location of the particular transmitter within the supermarket 1. This information may then be processed once received by a receiver 17 so as to allow the location of the associated shopping trolley 13 to be determined. Accordingly, once the location of a trolley 13 within the supermarket 1 has been determined in this way, it is possible for an electronic control unit to determine which displayed product is nearest to the shopping trolley 13. This determination may be made on the basis of a database of information relating to the products sold in the supermarket and the location of the products within the supermarket. Information relating to the nearest product to the shopping trolley 13 may then be communicated to the purchaser. This information may be stored in an electronic memory on the shopping trolley 13 or at a location remote to the shopping trolley 13 and transmitted to the shopping trolley 13 when requested. This is an alternative method to the transmission of product information by the transmitters 15 mounted on the shelf units 9. In the arrangement of FIG. 1, a remote electronic memory 23 for storing a database of product information for the supermarket 1 is located remote to the shop floor 3. A transmitter 25 is provided for wirelessly transmitting product information to a trolley 13 upon request by the trolley 13 (i.e. once the product nearest the trolley has been identified).

In order for a shopping trolley 13 to request information on a particular product from a remote location 23, it will be understood that the shopping trolley 13 must comprise a transmitter as well as a receiver 17. The receiver 17 may, therefore, be a transceiver. The transmitter 25 at the remote location 23 may also be a transceiver. In this way, the communication of information to and from the shopping trolley 13 may be made via the World Wide Web (i.e. via the internet).

Also, the aforementioned methods for determining the position of a shopping trolley 13 within the supermarket 1 may be supplemented by, or replaced by, the use of a GPS (Global Positioning System) signal which is received by a GPS receiver mounted on the shopping trolley 13.

Although in the schematic arrangement shown in FIG. 1, it will be understood that the means for communicating information to a purchaser is located at one end of the shopping trolley 13 and the receiver 17 (or transceiver) is located at the other end of the shopping trolley, in practise these components may be located together in an integral unitary device. This device may be retro fitted to existing conventional shopping trolleys and be removable for maintenance purposes. The device may also include a power supply means such as a rechargeable battery. This power supply means may be electrically connected to a solar panel mounted on the device or elsewhere on the shopping trolley and/or be connected to a dynamo driven by one or more wheels of the shopping trolley.

A plurality (ten in total) of shopping trolleys 13 are shown in FIG. 1 stacked into two groups of five. An alternative number of shopping trolleys may of course be accommodated in alternative embodiments. The system may be modular, allowing the capacity for receiving trolleys to be expanded or reduced in fixed multiples (for example, in multiples of ten). Whilst stacked in this location, the trolleys 13 are electrically connected to an electric battery which recharges the power supply means of each trolley 13. A number of arrangements for electrically charging shopping trolleys is shown in FIGS. 2 to 9 of the accompanying drawings.

With regard to FIG. 2, apparatus 100 is shown for electrically charging a plurality of shopping trolleys 13. The apparatus comprises left and right hand sides 102, 104. The left and right hand sides 102, 104 are mounted on a floor member 106 on which the wheels of a trolley 13 are supported during use. The left and right hand sides 102, 104 of the apparatus 100 are parallel to one another and spaced apart from one another by a distance approximately the same as the width of a shopping trolley 13. The arrangement is such that the sides 102, 104 define an elongate straight corridor in which a shopping trolley may be located and along which a shopping trolley 13 may be pushed with little or substantially no lateral movement of the trolley 13 relative to the apparatus 100.

The lateral movement of a shopping trolley 13 within the apparatus 100 is limited specifically by means of a first pair of elongate rails 108, 110 and a second pair of elongate rails 112, 114 (see FIG. 4 in particular). The first pair of rails 108, 110 locate on either side of a trolley 13 and abut with the rear legs 116 of the trolley 13 on which the rear wheels 118 of the trolley 13 are mounted. This limits lateral movement of the rear end of the trolley 13. Lateral movement of the front end of the trolley 13 is limited by the second pair of elongate rails 112, 114 which are mounted on the floor member 106 of the apparatus 100 and each abut a different one of the front wheels 120 of the shopping trolley 13. As will be evident from FIG. 4 in particular, it will be understood that the front wheels 120 are positioned closer together in a lateral direction than the rear wheels 118. As a result, the rear wheels 118 located on an upper surface of the second pair of rails 112, 114 as the trolley is moved along the apparatus 100. In order to assist the rear wheels 118 in locating on the second pair of rails 112, 114, each of the second pair of rails 112, 114 is provided with a sloping surface 122 which lifts the rear wheels 118 onto the upper surface of the second pair of rails 112, 114 as the trolley 13 is pushed through the entrance 123 of the apparatus 100.

Each of the first pair of the elongate rails 108, 110 is located at a height above the floor member 106 and comprises an elongate recess 124 extending along the length of the associated rail. Each recess 124 is provided with an elongate electrical conductor 126 which is electrically connected to a battery charger (not shown). In use, an electrical conductor 128 provided on each rear leg 116 of the trolley 13 locates in the recess 124 and is biased by means of a mechanical spring (not shown) into electrical contact with the electrical conductor 126. The conductor 128 mounted on each rear leg 116 of a trolley 13 is electrically connected to the power supply means (battery) associated with the electronic communication device and associated control system (for example, the display screen 19). In addition to, or as an alternative to, the biasing of the electrical conductor 128, the electrical conductor 126 may itself be provided with biasing means (for example, a mechanical spring (not shown)) for biasing the conductor 126 into electrical contact with the electrical conductor 128 of the trolley 13.

As is more clearly shown in the schematic plan view of FIG. 10, in one embodiment, each conductor 126 comprises separate conductor elements 200 electrically insulated from one another by insulator elements 202. The arrangement is such that, when the trolleys 13 are stacked together, the electrical conductors 128 on neighbouring trolleys 13 are connected to neighbouring conductor elements 200 separated by an insulator element 202. The conductor elements 200 are earthed and connected to the battery charger 204. Accordingly, each trolley 13 is electrically isolated from the other trolleys.

It will be understood therefore that a shopping trolley 13 which is no longer needed by a purchaser may be pushed through the entrance 123 of the apparatus 100 and located for storage between the left and right hand 102, 104 side of the apparatus 100. As soon as the connectors 126, 128 of the apparatus 100 and trolley 13 abut with one another, the battery of the trolley 13 begins to be charged. The battery of the trolley 13 continues to be charged even as the trolley is moved along its path from the entrance 123 towards the exit 130 of the apparatus 100. The battery of the trolley 13 will continue to be charged until the trolley 13 passes through the exit 130 and leaves the apparatus 100, thereby disconnecting the trolley conductor 128 from the charging apparatus conductor 126.

It will be appreciated that the conventional shape and general construction of the trolleys 13 shown in the accompanying drawings allows the trolleys 13 to be stacked for storage in the apparatus 100 whilst their batteries are recharged. Ideally, in order to maximise battery charging times, the first trolley 13 to enter the apparatus 100 is the first trolley 13 to be removed from the apparatus 100. Means may be provided for ensuring this is the case. These means may comprise a pair of control gates (or another type of barrier) 140 at the entrance 123 to the apparatus 100 and a second pair of gates 142 (or another type of barrier) at the exit 130 of the apparatus 100. The gates 140, 142 are hingedly mounted in such a way as to be pushed open in the same direction as one another. The gates 140, 142 are sprung biased to the closed position. In this way, the gates 140, 142 may be pushed open by a trolley 13 only when the trolley 13 is travelling in the one direction indicated by arrow 144 as shown in FIGS. 6 and 7 of the accompanying drawings. A trolley 13 moving in the opposite direction to that indicated by arrow 144 will merely press the gates 140, 142 against stops (not shown) retaining the gates 140, 142 in a closed position and thereby preventing passage of the trolley 13 therepast.

A release of a trolley 13 through the exit may be allowed only if a fee (which may be refundable) is paid by the trolley user. For example, the exit gates 142 may be coin operated, opening only if a coin is inserted into the apparatus 100. The fee may then be refunded automatically when the trolley is returned to the apparatus through the entrance 123. This refund may require a key (not shown), tethered to the trolley 13, to be inserted into the apparatus 100. Upon insertion of the key, a coin may be refunded. This will encourage a user to return a trolley 13 to the apparatus 100.

If necessary, the stops (not shown) associated with the gates 140, 142 may be selectively moved so as to allow the gates 140, 142 to open in either direction and allow a trolley 13 to be removed from the storage area of the apparatus 100 via the entrance 123 rather than the exit 130, and similarly for a trolley 13 to enter the storage area via the exit 130 rather than the entrance 123.

As shown in FIG. 3, a number of storage areas may be provided in parallel so as to allow a greater number of trolleys 13 to be stored and simultaneously charged.

The present invention is not limited to the particular embodiments described above. Alternative arrangements and suitable materials will be apparent to a reader skilled in the art. It will be also be appreciated that the information communicated to a purchaser may be provided in the form of text, video and/or advertisement.

1. A shopping container comprising an electronic device; characterised in that the electronic device comprises means for communicating with a purchaser of a product to be sold.

2. A shopping container according to claim 1, wherein the communicating means comprises an electronic display screen.

3. A shopping container according to claim 2, wherein the electronic display screen is a video screen and is preferably one of a 4.3 inch and 7 inch screen.

4. A shopping container according to claim 2, wherein the electronic display screen is an LCD screen.

5. A shopping container according to claim 2, wherein the electronic display screen is touch sensitive so as to allow a purchaser of a product to be sold to provide the communicating means with instructions and/or data by touching the electronic display screen.

6. A shopping container according to claim 1, wherein the communicating means comprises an electronic audio speaker.

7. A shopping container according to claim 1, wherein the communicating means comprises means for vibrating a part of the shopping container.

8. A shopping container according to claim 7, wherein said part of the shopping container comprises a handle by which the shopping container is moved during use.

9. A shopping container according to claim 8, wherein said handle is a bar.

10. A shopping container according to claim 1, wherein the communicating means comprises an electronic printer.

11. A shopping container according to claim 10, wherein the communicating means is adapted to print, by means of the electronic printer, information associated with a product to be sold.

12. A shopping container according to claim 11, wherein said information comprises one or more of product price information, product sell-by-date information and product technical information.

13. A shopping container according to claim 10, wherein the communicating means is adapted to print, by means of the electronic printer, product coupons entitling a purchaser to an effective reduction in the price of an associated product.

14. A shopping container according to claim 1, wherein the communicating means communicates with a purchaser of a product to be sold in response to instructions and/or data provided by said purchaser.

15. A shopping container according to claim 1, wherein the communicating means is adapted to communicate, to a purchaser, information associated with a product to be sold.

16. A shopping container according to claim 15, wherein said information associated with a product to be sold comprises one or more of product price information, product sell-by-date information, product technical information and advertising information.

17. A shopping container according to claim 1, wherein the communicating means is adapted to communicate, to a purchaser, information associated with product coupons entitling a purchaser to an effective reduction in the price of an associated product.

18. A shopping container according to claim 15, wherein the electronic device is adapted to communicate, to a purchaser, information associated with a product to be sold when the shopping container is within a predetermined distance of a location for displaying said product to be sold to a purchaser.

19. A shopping container according to claim 18, wherein said predetermined distance is between 0.5 m and 2.5 m, and is preferably between 1.5 m and 2.0 m, and is more preferably 1.5 m.

20. A shopping container according to claim 18, wherein the electronic device is adapted to allow a purchaser to select which one of a plurality of products within said predetermined distance is to be the subject of said information communicated to the purchaser.

21. A shopping container according to claim 1, wherein the electronic device comprises an electronic receiver for receiving an electronic signal transmitted from a location remote from the shopping container, preferably wherein the electronic receiver is a wireless receiver.

22. A shopping container according to claim 21, wherein the electronic receiver is adapted to receive an electronic signal comprising information for communicating to a purchaser.

23. A shopping container according to claim 22, wherein the electronic receiver is adapted for communicating with and receiving signals from the World Wide Web.

24. A shopping container according to any of claim 21, wherein the electronic receiver is adapted to receive an electronic signal comprising information for allowing the electronic device to identify the position of the shopping container relative to a location for displaying a product.

25. A shopping container according to claim 24, wherein said electronic signal comprises a Global Positioning System (GPS) signal.

26. A shopping container according to claim 1, wherein the electronic device comprises an electronic data storage means.

27. A shopping container according to claim 26, wherein the electronic data storage means stores information associated with products to be sold.

28. A shopping container according to claim 1, further comprising a power supply means for providing electric power to said electronic device.

29. A shopping container according to claim 28, wherein said power supply means comprises one or more of (i) a battery, (ii) a solar cell, and (iii) a dynamo driven by movement of the shopping container.

30. A shopping container according to claim 28, wherein the power supply means is integral with said electronic device.

31. A shopping container according to claim 28, further comprising an electrical connector for electrically connecting the shopping container to apparatus for electrically charging the power supply means.

32. A shopping container according to claim 31, further comprising means for biasing the electrical connector into electrical contact with the charging apparatus during use.

33. A shopping container according to claim 32, wherein said biasing means comprises a mechanical spring.

34. A shopping container according to claim 31, further comprising a downwardly extending leg on which the electrical connector is mounted.

35. A shopping container according to claim 1, wherein said electronic device is selectively removeable from the shopping container.

36. A shopping container according to claim 1, wherein said container is a shopping trolley.

37. A shopping container according to claim 1, wherein said container is a shopping basket.

38. A shopping container comprising a power supply means for providing electric power, and an electrical connector for electrically connecting the shopping container to apparatus for electrically charging the power supply means.

39. A shopping container according to claim 38, further comprising means for biasing the electrical connector into electrical contact with the charging apparatus during use.

40. A shopping container according to claim 39, wherein said biasing means comprises a mechanical spring.

41. A shopping container according to claim 38, further comprising a downwardly extending leg on which the electrical connector is mounted.

42. A shopping container according to claim 38, wherein said container is a shopping trolley.

43. A shopping container according to claim 38, wherein said container is a shopping basket.

44. A shopping container according to claim 38, wherein the shape of the shopping container is such as to allow said shopping container to be stacked with another like shopping container.

45. Apparatus for electrically charging one or more shopping containers as claimed in claim 38, the charging apparatus comprising one or more electrical connectors for electrically connecting the apparatus to one or more of said shopping containers.

46. Apparatus according to claim 45, further comprising a storage area in which one or more of said shopping containers is stored during use, and an entrance to and an exit from the storage area through which, in use, said one or more shopping containers pass.

47. Apparatus according to claim 46, wherein each electrical connector is located in the storage area so as to allow connection of said one or more shopping containers to the apparatus in a plurality of locations within the storage area.

48. Apparatus according to claim 47, wherein the or each electrical connector is located in the storage area so as to allow connection of said one or more shopping containers to the apparatus as said one or more shopping containers are moved, during use, within the storage area.

49. Apparatus according to claim 46, wherein the one or more electrical connectors comprises an elongate electrical conductor extending along a path between the entrance and the exit.

50. Apparatus according to claim 49, further comprising means for guiding movement of said one or more shopping containers along said path so as to maintain electrical connection of the apparatus with said one or more shopping containers.

51. Apparatus according to claim 50, wherein the guide means comprises at least a first elongate rail extending along said path.

52. Apparatus according to claim 51, wherein the guide means comprises at least a second elongate rail extending along said path, the first and second rails being spaced from one another along their length so as to allow said one or more shopping containers to locate and move therebetween.

53. Apparatus according to claim 52, wherein the first and second rails are spaced from one another along their length by approximately the width of one of said shopping containers.

54. Apparatus according to claim 51, wherein the or each rail comprises a recess along the length of the rail for receiving a part of said one or more shopping containers.

55. Apparatus according to claim 54, wherein said electrical connector is located in and along the length of said rail recess.

56. Apparatus according to claim 50, wherein said electrical connector is mounted on the guide means.

57. Apparatus according to claim 46, further comprising means for preventing said one or more of said shopping containers exiting the storage area through the entrance thereto.

58. Apparatus according to claim 46, further comprising means for preventing said one or more of said shopping containers entering the storage area through the exit thereto.

59. Apparatus according to claim 57, wherein said preventing means comprises a moveable barrier.

60. Apparatus according to claim 45, comprising means for releasing of a trolley 13 from the apparatus only if a fee is paid, in use, by the user of a shopping container.

61. Apparatus according to claim 45, comprising a key hole for receiving a key tethered to a trolley 13, wherein upon insertion of said key into the key hole, a refund of a fee is issued to the user of a shopping container.

62. Apparatus according to claim 45, further comprising means for biasing the or each electrical connector into electrical contact with a shopping container, preferably wherein the biasing means comprises a mechanical spring.

63. Apparatus according to claim 45, wherein the or each electrical connector comprising a plurality of electrical connector elements, and preferably wherein neighbouring elements are separated by electrically insulating elements.

64. A system comprising one or more shopping containers as claimed in as claimed in claim 45 for electrically charging one or more shopping containers.

65. A system according to claim 64, wherein said one or more shopping containers are electrically connected to the apparatus.

66. A system according to claim 65, wherein the arrangement of said apparatus is such that, in use, the first of said one or more shopping containers to be electrically connected to the apparatus must be the first of said one or more shopping containers to be electrically disconnected from the apparatus.

67. A system comprising a location for displaying a product to be sold to a purchaser; and a portable electronic device comprising means for communicating with a purchaser; characterised in that the portable electronic device is activated so as to communicate, in use, with a purchaser in response to said electronic device being positioned within a predetermined distance of said product location.

68. A shopping container according to claim 7 wherein said means for vibrating a part of the shopping container is programmed to be activated when said communicating means communicates, to a purchaser, information associated with a product to be sold.

69. A shopping container according to claim 68 wherein said means for vibrating a part of the shopping container is programmed to be activated at the beginning of said communication of information to a purchaser.

70. A shopping container according to claim 68 wherein said means for vibrating a part of the shopping container is programmed to be activated at random intervals.

71. A shopping container according to claim 68 wherein said means for vibrating a part of the shopping container is programmed to be activated when movement of the trolley is detected.

72. (canceled)

73. (canceled)

74. (canceled)
